(19) United States
(12) Patent Application Publication
(10) Pub. No.: US 2026/0177107 A1
(43) Pub. Date: Jun. 25, 2026

(54) SPLINE CONNECTING STRUCTURE HAVING LOCKING FUNCTION, AND IN-WHEEL DRIVING APPARATUS

(71) Applicant: Schaeffler Technologies AG & Co. KG, Herzogenaurach (DE)

(72) Inventor: Huaiwei Guo, Shanghai (CN)

(73) Assignee: Schaeffler Technologies AG & Co. KG, Herzogenaurach (DE)

(21) Appl. No.: 18/715,160

(22) PCT Filed: Dec. 2, 2021
(86) PCT No.: PCT/CN2021/135139

§ 371 Date: May 31, 2024

(51) Int. Cl. F16D 1/06; B60B 35/12

(52) U.S. Cl. CPC F16D 1/06; B60B 35/125

(57) ABSTRACT

A spline connecting structure having a locking function, and an in-wheel driving apparatus. The spline connecting structure includes: a first spline component, being provided with a plurality of first teeth; a second spline component, being provided with a plurality of second teeth, and the plurality of second teeth are in clearance fit with the plurality of first teeth. A locking piece is threadedly connected to the first spline component, and the locking piece abuts against the second spline component in the circumferential direction of the second spline component, thereby preventing the second spline component from rotating relative to the locking piece. The second spline component cannot rotate relative to the first spline component, and the contact surfaces of the first teeth and the second teeth are not repeatedly switched, and thus, the noise of the spline connecting structure can be eliminated or reduced.

### CROSS-REFERENCE TO RELATED APPLICATIONS

This application is the U.S. National Phase of PCT Appln. No. PCT/CN2021/135139, filed Dec. 2, 2021, the entire disclosure of which is incorporated by reference herein.

### TECHNICAL FIELD

The present application relates to a vehicle driving apparatus, and in particular to a spline connecting structure having a locking function, and an in-wheel driving apparatus.

### BACKGROUND

A spline connecting structure with clearance is known in the art.

For example, in an in-wheel driving apparatus, a brake drum is connected to a sun gear shaft via a spline structure. There is backlash between the teeth of the spline parts, that is, the spline parts of the brake drum and the spline of the sun gear shaft are loosely fitted rather than interference fitted.

In a non-braking state, the brake drum rotates almost freely with the sun gear shaft. However, as the speed of the sun gear fluctuates, an engagement surface between the spline parts of the brake drum and the spline parts of the sun gear shaft is switched repeatedly, resulting in noise.

### SUMMARY

The present disclosure is made in view of the state of the conventional art as described above. An objective of the present disclosure is to provide a spline connecting structure having a locking function and an in-wheel driving apparatus, with which noise from the spline connecting structure can be eliminated or reduced.

A spline connecting structure having a locking function is provided, including:

a first spline component, having multiple first teeth;

a second spline component having multiple second teeth, where the multiple second teeth are in clearance fit with the multiple first teeth; and

a locking member threadedly connected to the first spline component, where the locking member abuts against the second spline component in a circumferential direction of the second spline component, to prevent the second spline component from rotating relative to the locking member.

In at least one embodiment, the second spline component includes at least one accommodating portion recessed away from the locking member in an axial direction of the second spline component, the locking member includes at least one abutment portion, and a part of the abutment portion reaches into the accommodating portion in the axial direction and abuts against a side wall of the accommodating portion.

In at least one embodiment, the locking member includes an internal threaded ring, multiple abutment portions protrude from the internal threaded ring toward a radial outer side, the multiple abutment portions are separated by multiple notches distributed along the circumferential direction, and an axial thickness of at least an outer circumference of the abutment portion is less than an axial thickness of the internal threaded ring,

the accommodating portion is located on an end surface on a first side of the second spline component, a radial height of the accommodating portion is greater than a radial height of the abutment portion, and an outer circumference of the accommodating portion is located on a radial outer side of the abutment portion,

a part of the abutment portion is driven to reach into the accommodating portion by pressing the abutment portion.

In at least one embodiment, the multiple accommodating portions and the multiple abutment portions are uniformly arranged in the circumferential direction, the number of the accommodating portions is unequal to the number of the abutment portions, and the number of the abutment portions is not an integer multiple of the number of the accommodating portions.

In at least one embodiment, the accommodating portion extends in a radial direction of the second spline component, and an end of the accommodating portion close to a radial outer side of the second spline component is open.

In at least one embodiment, a width of the abutment portion in the circumferential direction is greater than a width of the accommodating portion in the circumferential direction.

In at least one embodiment, the spline connecting structure having a locking function further includes a retainer, where the retainer is sleeved on the first spline component and abuts against an end surface on a second side of the second spline component to axially stop the second spline component.

An in-wheel driving apparatus is provided, which includes the spline connecting structure having a locking function according to the present disclosure.

In at least one embodiment, the first spline component is a sun gear shaft, the second spline component is a brake drum, and the brake drum is integrally mounted on a radial outer side of the multiple first teeth.

In at least one embodiment, the second spline component includes:

an axial end wall, where the multiple second teeth are on an inner circumference of the axial end wall, and the accommodating portion is formed on an end surface on a first axial side of the axial end wall; and

an annular portion, protruding from an outer circumference of the axial end wall toward the first axial side.

The second spline component cannot rotate relative to the locking member, and the locking member is threadedly connected to the first spline component. Therefore, the second spline component cannot rotate relative to the first spline component, and the engagement surface between the first teeth and the second teeth is not switched repeatedly, so that noise from the spline connecting structure is eliminated or reduced.

### BRIEF DESCRIPTION OF THE DRAWINGS

FIG. 1 shows a perspective view of a spline connecting structure according to an embodiment of the present disclosure.

FIG. 2 shows an exploded view of a spline connecting structure as shown in FIG. 1.

FIG. 3 shows a sectional view of a spline connecting structure as shown in FIG. 1.

FIG. 4 shows a front view of a spline connecting structure as shown in FIG. 1.

### DETAILED DESCRIPTION

Exemplary embodiments of the present disclosure are described below with reference to the accompanying drawings.

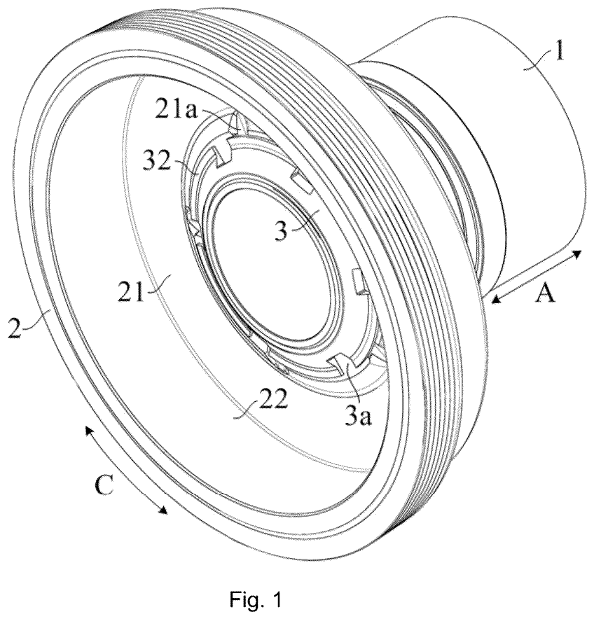

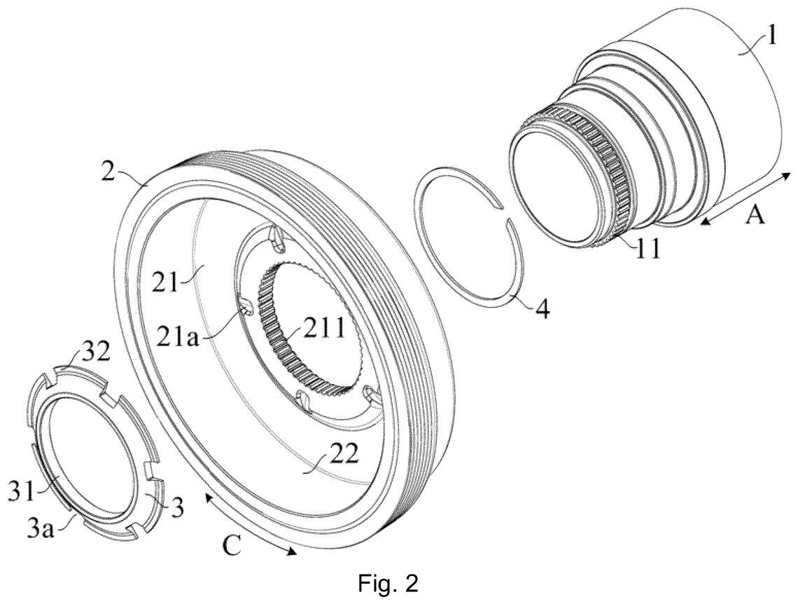

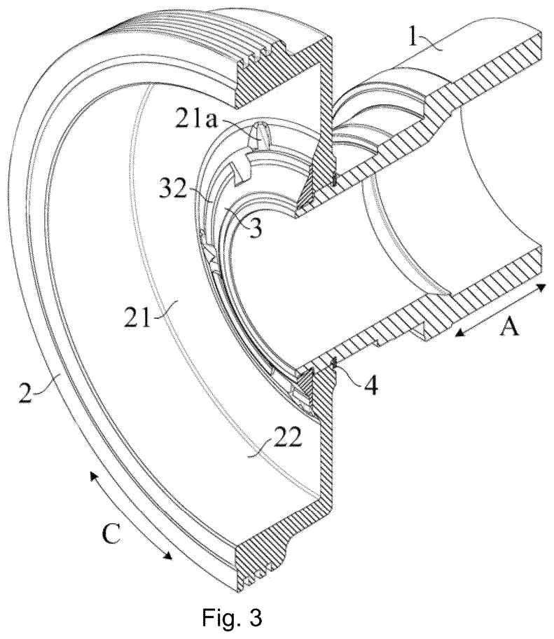

In the present disclosure, unless otherwise specified, an “axial direction” refers to an axial direction of a sun gear shaft, which is consistent with axial directions of a brake drum, a locking member, and a retainer. A “first axial side” refers to the left side in FIG. 1 to FIG. 3, and a “second axial side” refers to the right side in FIG. 1 to FIG. 3. A “circumferential direction” refers to a circumferential direction of the sun gear shaft, which is consistent with circumferential directions of the brake drum, the locking member, and the retainer. A “radial direction” refers to a radial direction of the sun gear shaft, which is consistent with radial directions of the brake drum, the locking member, and the retainer.

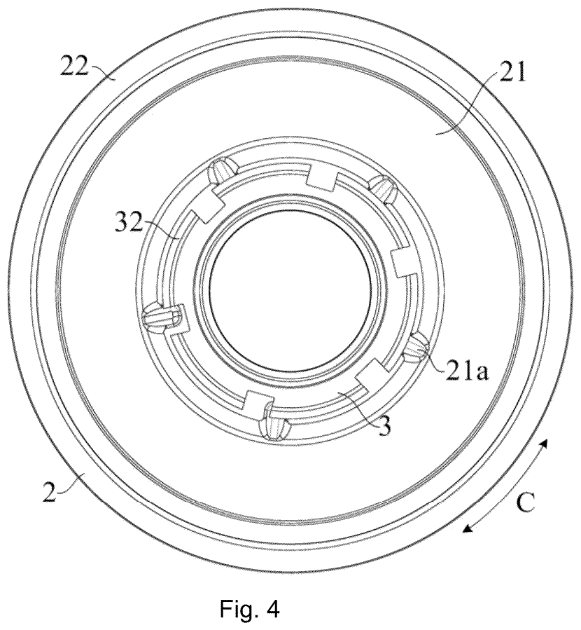

Referring to FIG. 1 to FIG. 4, a spline connecting structure having a locking function is provided according to an embodiment of the present disclosure. The spline connecting structure can be particularly, but not exclusively, applied to an in-wheel driving apparatus. It should be emphasized that showed in FIG. 1 to FIG. 4 is a state when a locking member 3 is not pressed.

The in-wheel driving apparatus includes a sun gear shaft 1 (an example of a first spline component), a brake drum 2 (an example of a second spline component), and the locking member 3. The sun gear shaft 1 has a cylindrical structure with two open ends, and an end on a first side is provided with multiple first teeth 11. The multiple first teeth 11 are uniformly arranged on an outer circumferential surface of the sun gear shaft 1 in a circumferential direction C to form a spline structure. The brake drum 2 includes an axial end wall 21 and an annular portion 22. The axial end wall 21 has an annular structure, and an inner circumferential surface of the axial end wall 21 is provided with multiple second teeth 211. The multiple second teeth 211 are uniformly arranged in the circumferential direction C to form a spline structure. The annular portion 22 protrudes from an outer circumference of the axial end wall 21 toward the first axial side. The brake drum 2 is sleeved on a radial outer side of the sun gear shaft 1, and the multiple first teeth 11 mesh with the multiple second teeth 211 to form spline connection. The multiple first teeth 11 are in clearance fit with the multiple second teeth 211, so that there is a gap between a side surface of a first tooth 11 and a side surface of a second tooth 211 which are opposite to each other in the circumferential direction C.

The locking member 3 includes an internal threaded ring 31 and an abutment portion 32. The abutment portion 32 is lamellate and protrudes from the internal threaded ring 31 toward a radial outer side. The abutment portion 32 may be perpendicular to the axial direction A to save space for the locking member 3 in the axial direction A. The locking member 3 is sleeved on the sun gear shaft 1 and is threadedly connected with the sun gear shaft 1. An end on the second axial side of the locking member 3 abuts against an end on the first axial side of the axial end wall 21. A part of the end on the first axial side of the axial end wall 21 corresponding to the abutment portion 32 is provided with an accommodating portion 21a. The accommodating portion 21a is recessed in a direction away from the locking member 3 along the axial direction A to form a groove structure.

The abutment portion 32 can be deformed by pressing, and a part of the abutment portion 32 corresponding to the accommodating portion 21a reaches into the accommodating portion 21a and abuts against a side wall of the accommodating portion 21a. The brake drum 2 cannot rotate relative to the locking member 3, and the locking member 3 cannot rotate relative to the sun gear shaft 1. Hence, the brake drum 2 cannot rotate relative to the sun gear shaft 1, and an engagement surface of the first teeth 11 and the second teeth 211 is not switched repeatedly. Hence, noise from the spline connecting structure can be eliminated or reduced.

The locking member 3 may further include multiple notches 3a. The notches 3a may be arranged in the circumferential direction C, so that multiple abutment portions 32 are formed from separations of the notches. Correspondingly, there may be multiple accommodating portions 21a. Hence, multiple abutment portions 32 can reach into multiple accommodating portions 21a, so that locking reliability is improved. In addition, with the abutment portions 32 being separated by the notches 3a, in a case where one of the abutment portions 32 is pressed, the remaining abutment portions 32 are not, or are not easily, affected by the pressed abutment portion 32 and deform accordingly. The locking member 3 can have a high reliability. In a case where the locking member 3 needs to be tightened on the sun gear shaft 1, a tool can reach into a notch 3a to abut against a side wall of the notch 3a and rotate the locking member 3. Hence, the difficulty of assembling the connecting structure is reduced, and usability of the connecting structure is improved.

It should be understood that, in a case where the multiple abutment portions 32 can all reach into the accommodating portions 21a, a user may determine to place only some of the abutment portions 32 into the accommodating portions 21a as required.

The multiple accommodating portions 21a and the multiple abutment portions 32 may be uniformly arranged in the circumferential direction C. The number of the accommodating portions 21a may be unequal to the number of the abutment portions 32, and the number of the abutment portions 32 need not be an integer multiple of the number of the accommodating portions 21a. In an example, the number of the accommodating portions 21a may be 5, and the number of the abutment portions 32 may be 6. With such arrangement, no matter how the locking member 3 rotates in the circumferential direction C, there is always at least one of the accommodating portions 21a that corresponds to at least one of the abutment portions 32 in the circumferential direction C. The assembly difficulty of the connecting structure is reduced, and the usability of the connecting structure is improved.

It should be understood that the number of the accommodating portions 21a may be greater than the number of the abutment portions 32.

An axial thickness of the abutment portion 32 may be less than an axial thickness of the internal threaded ring 31, and a thickness of a transition section between the abutment portion 32 and the internal threaded ring 31 may change gradually. Hence, when the abutment portion 32 is pressed, the internal threaded ring 31 is not, or is not easily, affected by the pressed abutment portion 32 and deformed accordingly. The locking member 3 can have a high reliability.

A radial height of the accommodating portion 21a may be greater than a radial height of the abutment portion 32, and an outer circumference of the accommodating portion 21a may be located on a radial outer side the abutment portion 32. Hence, when the locking member 3 abuts against the brake drum 2, the accommodating portion 21a is not completely blocked by the abutment portion 32. The user can easily observe a corresponding relationship between the accommodating portion 21a and the abutment portion 32, which facilitates pressing on the abutment portion 32.

The accommodating portion 21a may extend in the radial direction, and an end of the accommodating portion 21a close to a radial outer side of the brake drum 2 is open. Hence, when the locking member 3 needs to be disassembled, the user can easily insert a tool from the radial outer side to an interface between the abutment portion 32 and the accommodating portion 21a, to separate the abutment portion 32 from the accommodating portion 21a. The disassembly difficulty of the spline connecting structure is reduced, and the usability of the connecting structure is improved.

A width of the abutment portion 32 in the circumferential direction C may be greater than a width of the accommodating portion 21a in the circumferential direction C. Hence, when the locking member 3 rotates, the abutment portion 32 has a high probability of covering the accommodating portion 21a. This allows the user to easily rotate the locking member 3 to a proper position, thus improving usability of the spline connecting structure.

The in-wheel driving apparatus may further include a retainer 4. The retainer 4 is sleeved on the sun gear shaft 1 and abuts against an end on the second axial side of the axial end wall 21. Hence, the retainer 4 can limit the brake drum 2 in the axial direction A.

It should be understood that the above-mentioned embodiments are exemplary only and are not intended to limit the present disclosure. Those skilled in the art can make various modifications and changes to the above-mentioned embodiments according to the teaching of the present disclosure without departing from the scope of the present disclosure.

### LIST OF REFERENCE NUMERALS

1 First sun gear
11 First tooth
2 Brake drum
21 Axial end wall
211 Second tooth
21a Accommodating portion
22 Annular portion
3 Locking member
31 Internal threaded ring
32 Abutment portion
3a Notch
4 Retainer
A Axial direction
C Circumferential direction

1. A spline connecting structure having a locking function, the spline connecting structure comprising:
a first spline component having a plurality of first teeth;
a second spline component having a plurality of second teeth, wherein the plurality of second teeth are in clearance fit with the plurality of first teeth; and
a locking member threadedly connected to the first spline component, wherein the locking member abuts against the second spline component in a circumferential direction of the second spline component, to prevent the second spline component from rotating relative to the locking member.

2. The spline connecting structure having a locking function according to claim 1, wherein the second spline component comprises at least one accommodating portion recessed away from the locking member in an axial direction of the second spline component, the locking member comprises at least one abutment portion, and a part of the at least one abutment portion reaches into the at least one accommodating portion in the axial direction and abuts against a side wall of the accommodating portion.

3. The spline connecting structure having a locking function according to claim 2, wherein the locking member comprises an internal threaded ring and the at least one abutment portion includes a plurality of the abutment portions protruding from the internal threaded ring toward a radial outer side, the plurality of abutment portions are separated by a plurality of notches distributed along the circumferential direction, and an axial thickness of at least an outer circumference of the abutment portions is less than an axial thickness of the internal threaded ring,
the at least one accommodating portion is located on an end surface on a first side of the second spline component, a radial height of the at least one accommodating portion is greater than a radial height of the abutment portions, and an outer circumference of the at least one accommodating portion is located on a radial outer side of the abutment portion, and
a part of the abutment portion is driven to reach into the at least one accommodating portion by pressing the abutment portion.

4. The spline connecting structure having a locking function according to claim 2, wherein the at least one accommodating portion includes a plurality of the accommodating portions and the at least one abutment portion includes a plurality of the abutment portions are uniformly arranged in the circumferential direction, the number of the accommodating portions is unequal to the number of the abutment portions, and the number of the abutment portions is not an integer multiple of the number of the accommodating portions.

5. The spline connecting structure having a locking function according to claim 2, wherein the at least one accommodating portion extends in a radial direction of the second spline component, and an end of the at least one accommodating portion close to a radial outer side of the second spline component is open.

6. The spline connecting structure having a locking function according to claim 2, wherein a width of the at least one abutment portion in the circumferential direction is greater than a width of the at least one accommodating portion in the circumferential direction.

7. The spline connecting structure having a locking function according to claim 1, further comprising a retainer, wherein the retainer is sleeved on the first spline component and abuts against an end surface on a second side of the second spline component to axially stop the second spline component.

8. An in-wheel driving apparatus, comprising the spline connecting structure having a locking function according to claim 2

9. The in-wheel driving apparatus according to claim 8, wherein the first spline component comprises a sun gear shaft, the second spline component comprises a brake drum, and the brake drum is integrally mounted on a radial outer side of the plurality of first teeth.

10. The in-wheel driving apparatus according to claim 8, wherein the second spline component comprises:
an axial end wall, wherein the plurality of second teeth are on an inner circumference of the axial end wall, and the at least one accommodating portion is formed on an end surface on a first axial side of the axial end wall; and
an annular portion protruding from an outer circumference of the axial end wall toward the first axial side.

11. A spline connecting structure having a locking function, the spline connecting structure comprising:
a first spline component having a plurality of first teeth;
a second spline component having a plurality of second teeth, the plurality of second teeth engage the plurality of first teeth with a clearance fit; and
a locking member threadedly connected to the first spline component to hold the second spline component axially in engagement with the first spline component, the locking member abuts against a portion of the second spline component in a circumferential direction, to prevent the second spline component from rotating relative to the locking member.

12. The spline connecting structure having a locking function according to claim 11, wherein the second spline component comprises at least one accommodating portion recessed away from the locking member in an axial direction of the second spline component as the portion of the second spline component that the locking member abuts in the circumferential direction, the locking member comprises at least one abutment portion, and a part of the at least one abutment portion reaches into the at least one accommodating portion in the axial direction and abuts against a side wall of the accommodating portion.

13. The spline connecting structure having a locking function according to claim 12, wherein the locking member comprises an internal threaded ring and the at least one abutment portion includes a plurality of the abutment portions protruding from the internal threaded ring toward a radial outer side, the plurality of abutment portions are separated by a plurality of notches distributed along the circumferential direction, and an axial thickness of at least an outer circumference of the abutment portions is less than an axial thickness of the internal threaded ring,
the at least one accommodating portion is located on an end surface on a first axial side of the second spline component, a radial height of the at least one accommodating portion is greater than a radial height of the abutment portions, and an outer circumference of the at least one accommodating portion is located on a radial outer side of the abutment portion, and
a part of the abutment portion is driven to reach into the at least one accommodating portion by pressing the abutment portion.

14. The spline connecting structure having a locking function according to claim 12, wherein the at least one accommodating portion includes a plurality of the accommodating portions and the at least one abutment portion includes a plurality of the abutment portions are uniformly arranged in the circumferential direction, the number of the accommodating portions is unequal to the number of the abutment portions, and the number of the abutment portions is not an integer multiple of the number of the accommodating portions.

15. The spline connecting structure having a locking function according to claim 12, wherein the at least one accommodating portion extends in a radial direction of the second spline component, and an end of the at least one accommodating portion close to a radial outer side of the second spline component is open.

16. The spline connecting structure having a locking function according to claim 12, wherein a width of the at least one abutment portion in the circumferential direction is greater than a width of the at least one accommodating portion in the circumferential direction.

17. The spline connecting structure having a locking function according to claim 11, further comprising a retainer, wherein the retainer is sleeved on the first spline component and abuts against an end surface on a second side of the second spline component to axially stop the second spline component.

18. An in-wheel driving apparatus, comprising the spline connecting structure having a locking function according to claim 12.

19. The in-wheel driving apparatus according to claim 18, wherein the first spline component comprises a sun gear shaft, the second spline component comprises a brake drum, and the brake drum is integrally mounted on a radial outer side of the plurality of first teeth.

20. The in-wheel driving apparatus according to claim 18, wherein the second spline component comprises:
an axial end wall, wherein the plurality of second teeth are on an inner circumference of the axial end wall, and the at least one accommodating portion is formed on an end surface on a first axial side of the axial end wall; and
an annular portion protruding from an outer circumference of the axial end wall toward the first axial side.
